(19) United States
(12) Patent Application Publication
(10) Pub. No.: US 2009/0070246 A1
(43) Pub. Date: Mar. 12, 2009

(54) Electronic Financial Transaction Routing

(75) Inventor: Craig A. Tieken, Omaha, NE (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First Data Corporation, Greenwood Village, CO (US)

(21) Appl. No.: 11/852,408

(22) Filed: Sep. 10, 2007

(51) Int. Cl. G06Q 40/00

(52) U.S. Cl. 705/35

(57) ABSTRACT

Methods and systems for determining a network for settling an electronic transaction at a financial transaction processor is disclosed according to embodiments of the invention. Certain embodiments include receiving a transaction from a merchant. The transaction may includes a bank identification number (BIN) and a geographical state identifier associated the merchant. From the BIN number, the processor can determine if one or more network flags are asserted for the BIN in the network file. If a single network flag is asserted then routing the transaction through a network associated with the network flag. For example, if a state network flag is asserted then routing the transaction through the state associated with the transaction. If a network priority flag is asserted, routing the transaction through associated network. If an issuer priority flag is asserted, routing the transaction through the network associated with the issuer.

### BACKGROUND OF THE INVENTION

The present invention relates to systems and methods for routing electronic transactions through debit/credit networks, and more particularly to determining the proper network for routing of electronic transactions. In one aspect, the invention is particularly useful in cases where rules are in conflict and whether to default to routing through a least cost network.

Due to increase of electronic transactions in the marketplace, the cost and volume of such transactions have become a concern for merchants and debit processors. In performing commercial electronic transactions, merchants and debit processors have many debit networks from which to choose, and a variety of rules which are meant to bind processors to process transactions over a specific network. Determining a network where a transaction should be processed can be challenging especially when a conflict between network rules exist.

Consequently, there is a need for improved systems and methods for determining which network a transaction should be processed.

### BRIEF SUMMARY OF THE INVENTION

A method for determining a network for settling an electronic transaction at a financial transaction processor is disclosed according to one embodiment of the invention. The method includes receiving a transaction from a merchant that may include a bank identification number (BIN), including a state and/or network priority identifier. The method may determine if one or more network flags are asserted in a network BIN table and then route the transaction according to the network BIN table or according to a least cost network. For example, if a single network flag is asserted, then the transaction is routed through a network associated with the network flag. If a plurality of network flags are asserted, then routing the transaction through the least cost network of the networks associated with the plurality of network flags. If no network flags are asserted, then routing the transaction through the least cost network.

The method may further include determining whether the state where the transaction was initiated is in a state routing table. If the initiating state is in the state routing table, then routing the transaction through the network associated with the state. The states that may require a state network are Nebraska, Iowa, Alaska, and Puerto Rico.

Another method for determining a network for settling an electronic transaction at a financial transaction processor is disclosed according to another embodiment of the invention. The method may include determining whether a network BIN table includes one or more priority flags asserted for networks in relation to the BIN associated with the transaction. If more than one network is flagged as priority, then routing the electronic transaction through the least cost of the more than one networks. If only a single network is flagged as priority, then routing the transaction through the single priority flagged network. The method may further include determining whether the network BIN table includes one or more valid-flags asserted for networks in relation to the BIN. If more than one network is flagged as valid, then routing the electronic transaction through the least cost of the more than one networks. If only a single network is flagged as valid then routing the transaction through the single valid-flagged network. If no networks are flagged as valid or priority, then routing the transaction to the least cost network.

The method may further comprise determining if the geographical state where the transaction is initiated is a state requiring state prioritization. If so, routing the transaction through the geographical state network. The method may also include determining whether the NYCE network is flagged as valid or priority in a network BIN table for a BIN associated with the electronic transaction. If the NYCE network is flagged routing the transaction through the NYCE network.

A computer system for routing a electronic financial transactions is disclosed according to another embodiment of the invention. The computer system may include a network interface; a processor; and a memory. The memory may include at least one network BIN table and number of instructions. These instructions may include instructions to receive an electronic financial transaction from a merchant through the network interface. The instruction may also include instructions to lookup the BIN associated with the electronic financial transaction in the network BIN table and instructions to determine whether one or more priority flags are asserted in the network BIN table. The memory may include instructions to route the electronic financial transaction to a network if a single network is flagged as priority for the BIN associated with the electronic financial transaction, The memory may further include instructions to route the electronic financial transaction to the least cost network of the networks flagged as priority, if a more than one network is flagged as priority for the BIN associated with the electronic financial transaction.

The computer system memory may also include further instructions. For instance, the memory may include instructions to determine whether one or more valid flags are asserted in the network BIN table. The instructions may determine whether a single network is flagged as valid for the BIN associated with the electronic financial transaction. If a single network is flagged as valid, the transaction may be routed to that network. Otherwise, the transaction is routed to the least cost network of the flagged networks.

The computer system memory may also include a state table. The memory may further include instructions to route an electronic financial transaction to the state network specified in the state table if the electronic financial transaction was initiated with a state listed in the state table.

Further areas of applicability of the present disclosure will become apparent from the detailed description provided hereinafter. It should be understood that the detailed description and specific examples, while indicating various embodiments, are intended for purposes of illustration only and are not intended to necessarily limit the scope of the disclosure.

### BRIEF DESCRIPTION OF THE DRAWINGS

FIG. 1 shows a system for routing of electronic debit and/or credit transactions in according to one embodiment of the invention.

FIG. 2A shows a network BIN table according to one embodiment of the invention.

FIG. 2B shows a geographic BIN table 250 according to one embodiment of the invention.

FIG. 3 shows a flowchart for determining a network to send a debit/credit card transaction according to one embodiment of the invention.

FIG. 4 shows another flowchart for determining a network to route an electronic transaction according to one embodiment of the invention.

In the appended figures, similar components and/or features may have the same reference label. Where the reference label is used in the specification, the description is applicable to any one of the similar components having the same reference label.

### DETAILED DESCRIPTION OF THE INVENTION

The ensuing description provides preferred exemplary embodiment(s) only, and is not intended to limit the scope, applicability or configuration of the disclosure. Rather, the ensuing description of the preferred exemplary embodiment(s) will provide those skilled in the art with an enabling description for implementing a preferred exemplary embodiment. It being understood that various changes may be made in the function and arrangement of elements without departing from the spirit and scope as set forth in the appended claims.

In one embodiment, the present disclosure provides for routing PIN and PINless credit/debit card transactions to a credit/debit card network. Some network providers require all electronic financial transactions associated with a bank identification number (BIN) to be routed through their network. Some issuers of debit/credit cards require electronic financial transactions using their cards to be routed through preferred networks. Other issuers and/or networks are more permissive and allow electronic financial transactions to be routed through one or more valid networks. Moreover, some states require transactions initiated within the state to be routed to a state authorized network. Some networks and/or issuers inadvertently or improperly assert that they are the priority network for a certain BIN. The methods and systems that embody the present invention route electronic transactions to either the proper network or the least cost network depending on information regarding the state of the transaction, the valid networks and the priority networks.

In another embodiment, the present disclosure provides for electronic transaction routing based on information based within a network BIN table, including a state and/or network priority indicator. A network BIN table may contain information regarding priority and valid networks for each BIN. Thus, when a transaction arrives at a financial processor, the processor may determine which networks are a priority and which networks are valid based on the network BIN table. Moreover, the state table may guide whether the electronic transaction should be routed through a state specified network.

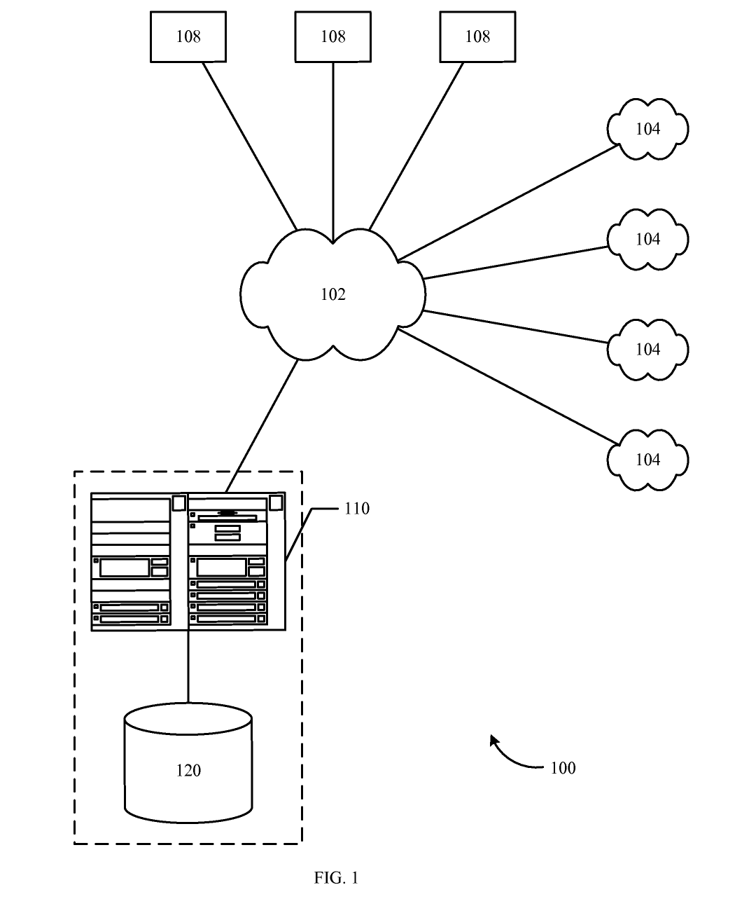

FIG. 1 shows a system for routing of electronic debit and/or credit transactions in according to one embodiment of the invention. System 100 can be implemented in communications network environment (generally indicated by reference number 102). Communications network 102 can be any network capable of supporting electronic debit and/or credit transactions including ATM transactions. Exemplary system 100 comprises electronic transaction terminals 108 located at various merchant locations in communication with a computer/server 110. The computer/server 110 is in turn in communication with at least one database 120 and one or more debit/credit networks 104. The computer/server may be operated and/or maintained by a transaction processor. Merely by way of example, electronic transaction terminals 108, server 110, database 120 and debit/credit networks 104 may be in communication via any suitable communications network 102, such as a local area network, wide area network, the internet and/or any other telecommunications network, a wireless network and the like. Computer/server 110 may be located at a service provider location.

Electronic transaction terminal 108 may be a point-of-sale terminal, an automated teller machine terminal, a cash register terminal, an electronic check verification terminal, etc. However, the invention is not so limited, and any suitable electronic transaction terminal known in the art may be used in connection with the present invention.

Debit/Credit Network 104 may be any known debit or credit network, including those operated by STAR®, PULSE®, INTERLINK®, MAESTRO®, CU24®, AFFN®, ACCEL®, EXCHANGE®, NETS®, SHAZAM®, ATH®, ALASKA OPTION®, JEANIE®, TEMPO PAYMENTS®, CIRRUS®, FASTBANK®, INSTANT CASH®, MINIBANK®, MONEY NETWORK®, PEAK®, PLUS®, NYCE®, ALERT®, VISA®, MasterCard®, DISCOVER®, American Express®, etc. However, the invention is not so limited, and any debit and/or credit network available in the geographic location of interest may be used in the context of the present invention.

In particular embodiments, system 100, server 110, and/or electronic transaction terminal 108 can, in some embodiments, comprise a plurality of processors. Each of the plurality of processors can perform one or more of the processing tasks discussed herein. Further, each of the plurality of processors can be in communication with one or more computer readable media, including, for instance disk drives, memory devices and the like which can include instructions executable by the processors to perform the functions discussed herein.

In accordance with various embodiments of the invention, system 100 can include one or more database 120, which can be used to store a variety of information related to the inventive methods discussed herein such as the transaction table array described above. Those skilled in the art will appreciate that although, for purposes of clarity, database 120 is illustrated as a single entity in FIG. 1, other embodiments of the invention might incorporate stored data within a plurality of database and/or organize data structures differently than as illustrated herein. Further, although illustrated as separate physical elements in FIG. 1, database 120 may alternatively be housed within server computer 110 (as indicated by the dashed line in FIG. 1). As discussed herein, when reference is made to server computer 110 including or comprising a database, it is understood that the database may be within the computer housing itself, or may be a separate structure in communication with server computer 110.

As will be discussed in more detail below, database 120 may comprise various combinations of transaction tables and/or network BIN tables for use during routing of electronic transaction in accordance with the methods of the invention. By way of non-limiting example, database 120 may comprise network bin tables listing BIN numbers and the networks that are priority or are authorized for the associated BIN. Database 120 may also include transaction tables listing debit/credit networks sorted by transaction fee charged by the debit/credit network for the particular transaction for which the table has been generated.

Those skilled in the art will recognize that there are a variety of ways of storing composite information in a database, any of which can be implemented in accordance with various embodiments of the invention. Further, those skilled in the art will recognize that there are a variety of ways in which server computer 110 might interface with database 120. In a particular aspect server 110 can access information in database 120 on a periodic basis or on demand. Various standardized (e.g., OOBC, SQL, XML, etc.) and/or proprietary data access methodologies known in the art may be used to access database 120. Further, data may either be pushed from a database or “pulled” by server 110.

Alternatively, database 120 and/or server 110 can engage in a practice known in the art as “push-pull” data warehousing, whereby information can be shared with and/or pulled from another source. Such data warehousing can be done within an enterprise or between multiple enterprises and can be performed using any of a variety of methods known to those skilled in the art including, merely by way of example, XML data transfers. In these and other ways, embodiments of the present invention, as discussed above, can interface with an information bus operation on an intra-company or inter-company basis, and can both pull information from that bus and push information to the information bus. Thus, systems in accordance with embodiments of the invention can easily integrate with other data management systems in the provider's network, for example by utilizing the information bus methodology described briefly herein and known to those skilled in the art.

In another aspect of the invention, methods for determining which electronic transaction a transaction should be sent are provided. As mentioned above, the methods generally involve providing a network BIN table and determining a proper network to route the transaction based on the network BIN for the electronic transaction.

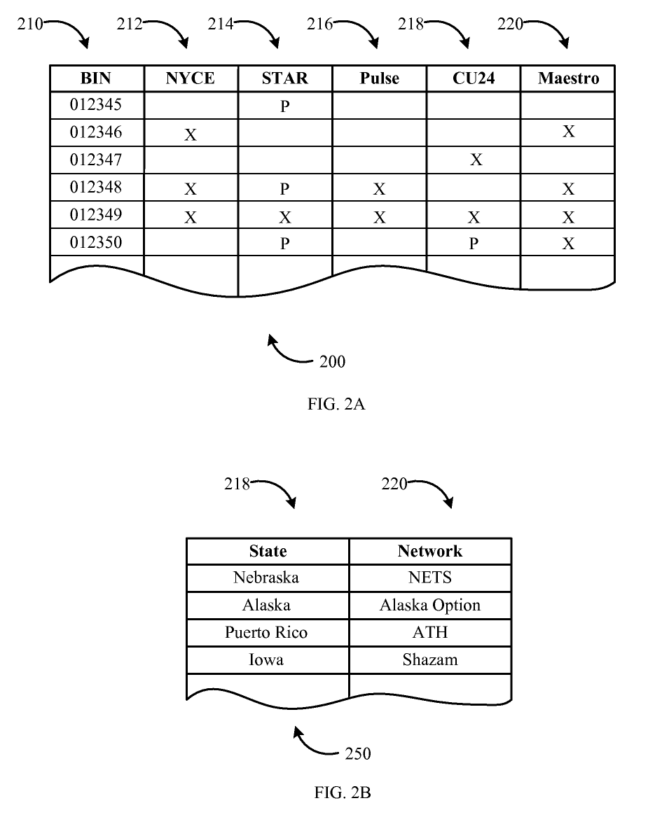

FIG. 2A shows a network BIN table according to one embodiment of the invention. The network BIN table associates BIN with valid and priority networks. A valid network is a debit/credit card network that may be used to settle a transaction between a financial institution and a consumer using debit/credit card. Some debit/credit cards permit a number of different debit/credit networks to settle a transaction. For example, debit/credit card issuers may choose which network, if any, take priority. If not network takes priority than a number of networks may be valid for a transaction. A priority network is a debit/credit network that is supposed to be used to settle a transaction between a financial institution and consumer using a debit/credit card. The network may require that a debit/credit card by processed through a specific network. For example, the CU24® and STAR® networks require that debit/credit cards transactions that are associated with these networks be routed through either of these networks. These networks take priority over other networks when flagged in the network BIN table as a priority network.

In another embodiment of the invention, an Issuer Identification Number (IIN) is used instead of a BIN. An IIN is registered with the American Bankers Associated and identifies the issuer of a debit/credit card.

The network BIN table shown in FIG. 2A shows a BIN column 210 and a number of network columns 212, 214, 216, 218, 220. The BIN column 210 includes a number of BIN numbers. If a BIN is valid for routing with a debit/credit network the table location associated with the BIN and the network is marked with an “X”. If a network takes priority for a given BIN, then the table location is marked with a “P”. Various ways of making validity and prioritization may be used. Various other types of tables, files or charts may be used to associate BINs with valid and priority networks. While the table 200 includes only five network columns, any number of network columns may be included.

In the network BIN table 200, the first BIN “012345” has a “P” in the “STAR®” column 214 and no other flags are asserted. As such, the STAR® network takes priority and a transaction associated with the BIN should be routed to the STAR® network. The second BIN “012346” has an “X” in both the “NYCE” and the “Maestro” columns 212, 220. As such, the financial institution processor must determine which of the two networks to send a transaction. The third BIN “012347” has an “X” in the “CU24®” column 218. The BIN “012348” has an “X” in the “NYCE”, “Pulse®”, and “Maestro” columns 212, 216, 220; and a “P” in the “STAR®” column. Accordingly, the STAR® network takes priority over the other networks. The BIN “012349” has each column asserted with an “X”. Finally, the table shows the “012350” BIN with the “STAR®” and “Pulse®” networks with priority and the Maestro network available.

Similar information may be stored in a variety of ways. The BIN-network information, for example, may be stored in a relational database or a linked list. The information need not be stored in a table format.

FIG. 2B shows a geographic BIN table 250 according to one embodiment of the invention. While states are used as a geographic area, any table associating a geography with a network or networks may be used. Even in this chart Puerto Rico is included, which is not technically a state, but rather a territory. The table includes two columns “State” 218 and “Network” 220. Only four rows are shown, but other states or geographic boundaries may be included beyond four. Accordingly, the state of Nebraska requires all debit/credit transactions to be routed to the NETS® network; Alaska requires the Alaska Option® Network, Puerto Rico requires the ATH network and Iowa requires the Shazam® network.

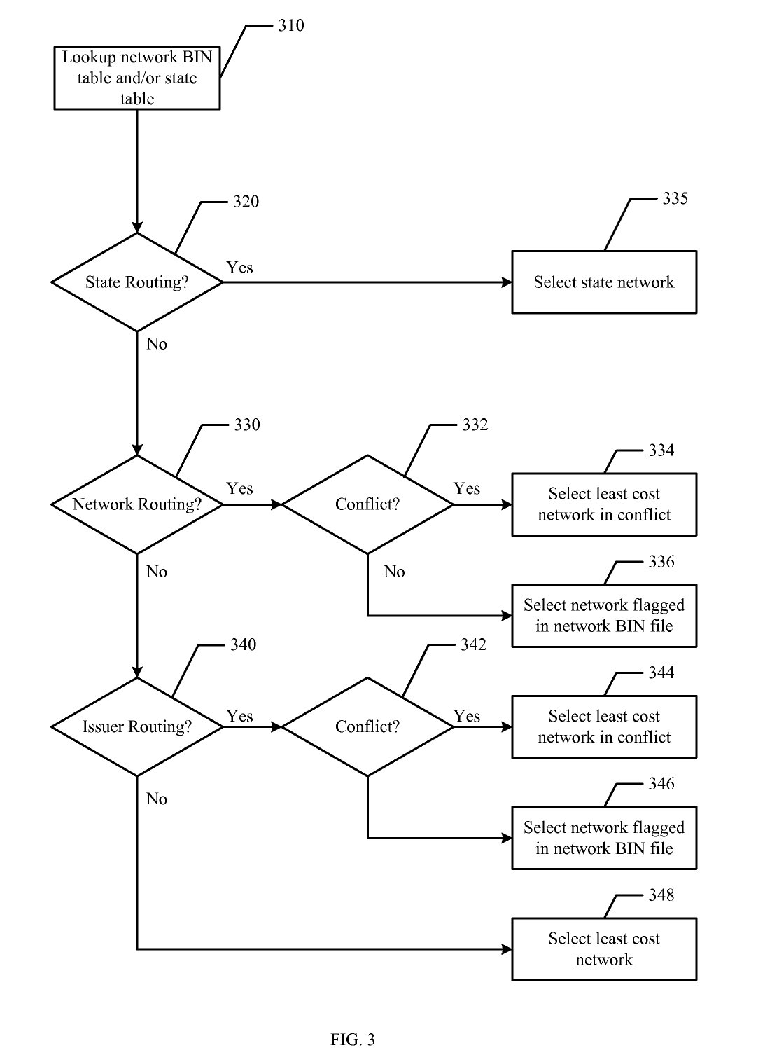

FIG. 3 shows a flowchart for determining a network to send a debit/credit card transaction according to one embodiment of the invention. Once a transaction is received from a point of sale device, a customer or a web site, the financial institution processor looks up the BIN in a network BIN table and/or the state table at block 310, for example the tables shown in FIGS. 2A and 2B. The system then determines whether the transaction is subject to state routing requirements by determining if the transaction was initiated in a state listed in the state table at block 320. If the transaction was initiated in a state listed in the geographic state table, then the network associates with the state is selected at block 335 and the transaction is routed to that network. An exemplary state table is shown in FIG. 2B.

If the transaction was not initiated in a state requiring state specific routing, a determination is made whether a network rule is in place at block 330. A network may require that debit/credit cards associated with a specific BIN be routed through that network. Accordingly, in the network BIN table, such networks have priority over other networks. For example, in the network BIN table, BIN “012345” includes a “P” in the “STAR®” column 214; therefore, transactions using that BIN are routed through the STAR® network. The STAR® network and the CU24® network may have network priority for some or all debit/credit card transactions.

At block 332 a determination is made whether there is a network routing priority conflict between two or more networks. If two networks have flagged a BIN in a network BIN file as priority and created a conflict as shown, for example, in FIG. 2A in regard to BIN “012350” where both the STAR® and CU24® have been flagged as priority, then a conflict has arisen between the two networks as shown in block 332. If only a single network is flagged as priority, for example, BIN “012134” as shown in FIG. 2A, then that network is selected and the transaction is routed to that network as shown in block 336. If there is a conflict, then a least cost network is determined, the least cost network is selected, and the transaction is routed accordingly at block 334. There are a variety of algorithms, methods, and/or systems that may be used to determine the least cost network. U.S. patent application Ser. No. 11/682,856 filed 6 Mar. 2007 entitled “Least Cost Network Routing for Electronic Transactions” includes various examples and disclosures of least cost routing of electronic financial transactions, which is incorporated by references in its entirety for all purposes.

If a network has not required a specific network for routing at block 330, then a determination is made whether the debit/credit card issuer has a required a specific network. Some issuers, may require priority for a specific network by flagging a network as a priority, while others may be more permissive and flag networks as valid in the network BIN file. If there is no conflict between multiple networks in the BIN network table, at block 342, then the transaction is sent to the network associated with the flagged network at block 346. If there are conflicts, as determined at block 342, then the least cost network of the conflicting networks may be selected at block 344.

Conflicts between networks can occur in a number of ways. For example, a network may insist upon a specific network for priority while an issuer may insist upon a different network for priority for the same BIN. Some issuers may not indicate a priority network, but may indicate a number of valid networks, for example, the BIN associated with “012349” in FIG. 2A shows five networks as valid. Some networks may also flag every valid network within the network BIN table. Moreover, issuers and networks may inadvertently flag multiple networks as priority or valid in the network BIN table for the same BIN.

If the network and the issuer do not indicate any routing requirements for BIN in the network BIN table, then the least cost network is selected, at block 348, and the transaction is passed to the least cost network.

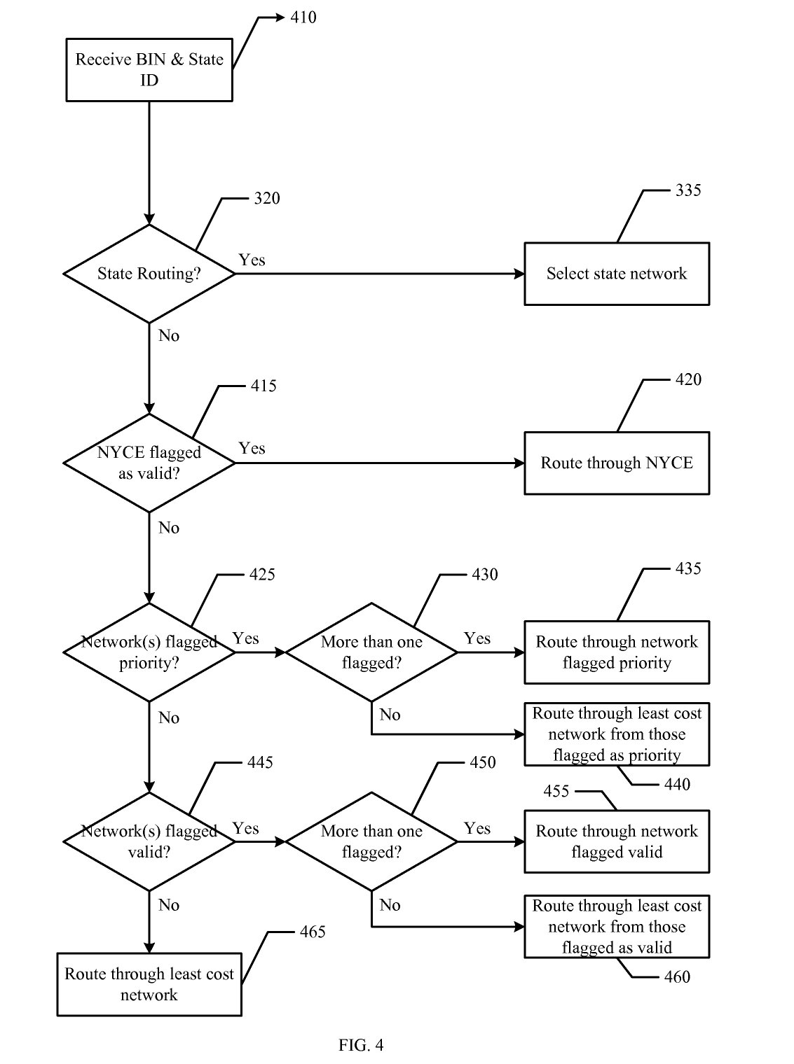

FIG. 4 shows another flowchart for determining a network to route an electronic transaction according to one embodiment of the invention. An electronic transaction is received by a processor at block 410. The electronic transaction may include a BIN and a state identifier. If the state associated with the state identifier requires a state specified network, at block 320, then the state network is selected at block 335. If there is now state routing, then the system determines if the NYCE® network is flagged as a valid network to route the transaction at block 415. If the NYCE® network is flagged as valid, then the transaction is routed through the NYCE® network at block 420. If the NYCE® network is not flagged as valid at block 415, then system determines which networks are flagged as priority for the BIN in the network BIN table at block 425. If more than one networks are flagged as a priority at block 430, then the electronic financial transaction is routed through the least cost network of the networks flagged as priority at block 440. If only one network is flagged as priority, then the transaction is routed to that network at block 435.

If no networks are flagged as priority, the system then determines which, if any, networks are flagged as valid in the network BIN table at block 445. If more than one network is flagged as valid, as determined at block 450, then the transaction is routed through the least cost valid network at block 460. If only one network is flagged as valid, at block 450, then the transaction is routed through that one valid network at block 455. If there are no networks flagged as valid or priority, then the transaction is routed to the overall least cost network.

The methods and/or flowcharts described above may be implemented by a computer system, server computers, a combination of computers and/or servers, and the like. The methods and/or flowcharts may be followed by an algorithm coded in software and operable to control a computer system to perform the steps described in the method. The software may be stored in memory or some other physical medium.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Implementation of the techniques, blocks, steps and means described above may be done in various ways. For example, these techniques, blocks, steps and means may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above and/or a combination thereof.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be rearranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages and/or any combination thereof. When implemented in software, firmware, middleware, scripting language and/or microcode, the program code or code segments to perform the necessary tasks may be stored in a machine readable medium, such as a storage medium. A code segment or machine-executable instruction may represent a procedure, a function, a subprogram, a program, a routine, a subroutine, a module, a software package, a script, a class, or any combination of instructions, data structures and/or program statements. A code segment may be coupled to another code segment or a hardware circuit by passing and/or receiving information, data, arguments, parameters and/or memory contents. Information, arguments, parameters, data, etc. may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, wireless channels and/or various other mediums capable of storing, containing or carrying instruction(s) and/or data.

While the principles of the disclosure have been described above in connection with specific apparatuses and methods, it is to be clearly understood that this description is made only by way of example and not as limitation on the scope of the disclosure.

What is claimed is:

1. A method for determining a network for settling an electronic transaction at a financial transaction processor, the method comprising:
receiving a transaction from a merchant, wherein the transaction includes a bank identification number (BIN) and a geographical state identifier associated the merchant;
determining if one or more network flags are asserted in a BIN network file;
if a single network flag is asserted, routing the transaction through a network associated with the network flag;
if a plurality of network flags are asserted, routing the transaction through the least cost network of the networks associated with the plurality of network flags; and
if no network flags are asserted, routing the transaction through the least cost network.

2. The method according to claim 1, further comprising determining if the geographical state identifier identifies a state requiring state prioritization and routing the transaction through the geographical state network if the geographical state does require state prioritization.

3. The method according to claim 2, wherein a state require state prioritization is selected from the list consisting of Puerto Rico, Nebraska, Iowa and Alaska.

4. A method for determining a network for settling an electronic transaction at a financial transaction processor, the method comprising:
determining whether the network BIN table includes one or more priority flags asserted for networks in relation to the BIN, wherein if more than one network is flagged as priority, routing the electronic transaction through the least cost of the more than one networks, otherwise, routing the transaction through the single priority flagged network; and
determining whether the network BIN table includes one or more valid-flags asserted for networks in relation to the BIN, wherein if more than one network is flagged as valid, routing the electronic transaction through the least cost of the more than one networks, otherwise, routing the transaction through the single valid-flagged network.

5. The method according to claim 4, further comprising determining if the geographical state is a state requiring state prioritization and routing the transaction through the geographical state network if the geographical state does require state prioritization.

6. The method according to claim 4, further comprising determining whether the NYCE network is flagged as valid or priority in a network BIN table for a BIN associated with the electronic transaction, and, if so, routing the transaction through the NYCE network.

7. A computer system for routing a electronic financial transactions comprising:
a network interface;
a processor; and
a memory, wherein the memory comprises:
at least one network BIN table;
instructions to receive an electronic financial transaction from a merchant through the network interface;
instructions to lookup the BIN associated with the electronic financial transaction in the network BIN table;
instructions to determine whether one or more priority flags are asserted in the network BIN table;
instructions to route the electronic financial transaction to a network if a single network is flagged as priority for the BIN associated with the electronic financial transaction; and
instructions to route the electronic financial transaction to the least cost network of the networks flagged as priority, if a more than one network is flagged as priority for the BIN associated with the electronic financial transaction.

8. The computer system for routing an electronic financial transaction according to claim 7, wherein the memory further comprises instructions to determine whether one or more valid flags are asserted in the network BIN table.

9. The computer system for routing an electronic financial transaction according to claim 8, wherein the memory further comprises instructions to route the electronic financial transaction to a network if a single network is flagged as valid for the BIN associated with the electronic financial transaction.

10. The computer system for routing an electronic financial transaction according to claim 8, wherein the memory further comprises instructions to route the electronic financial transaction to the least cost network of the networks flagged as valid, if a more than one network is flagged as valid for the BIN associated with the electronic financial transaction.

11. The computer system for routing an electronic financial transaction according to claim 7, wherein the memory further comprises a state table.

12. The computer system for routing an electronic financial transaction according to claim 11, wherein the memory further comprises instructions to route the electronic financial transaction to the state network specified in the state table if the electronic financial transaction was initiated with a state listed in the state table.

13. The computer system for routing an electronic financial transaction according to claim 7, wherein the electronic financial transaction is routed to the network through the network interface.

14. The computer system for routing an electronic financial transaction according to claim 7, wherein the processor further comprises instructions to route the electronic financial transaction to the least cost network if no network flags are asserted in the network BIN table for the BIN associated with the electronic financial transaction.
